(19) United States
(12) Patent Application Publication
(10) Pub. No.: US 2020/0375081 A1
(43) Pub. Date: Dec. 3, 2020

(54) Apparatus, Systems And Methods For Row Cleaner Depth Adjustment On-The-Go

(71) Applicant: Ag Leader Technology, Ames, IA (US)

(72) Inventor: Joe Holoubek, Ames, IA (US)

(21) Appl. No.: 16/891,812

(22) Filed: Jun. 3, 2020

Related U.S. Application Data
(60) Provisional application No. 62/856,250, filed on Jun. 3, 2019.

(51) Int. Cl. A01B 63/00; A01B 35/16; A01B 63/24; A01C 5/06

(52) U.S. Cl. CPC A01B 63/008; A01C 5/064; A01B 63/24; A01B 35/16

(57) ABSTRACT

The disclosure relates to an on-the-go system for adjustment of various aspects of a planting row unit. The on-the-go system is able to vary the depth of the row cleaner by adjusting the downforce applied to the row cleaner to promote planting at an optimal seed depth and soil moisture while preventing late emergence.

### CROSS-REFERENCE TO RELATED APPLICATION(S)

This application claims the benefit under 35 U.S.C. § 119(e) to U.S. Provisional Application 62/856,250, filed Jun. 3, 2019, and entitled “Apparatus, Systems and Methods for Row Cleaner Depth Adjustment On-The-Go,” which is hereby incorporated herein by reference in its entirety for all purposes.

### TECHNICAL FIELD

The disclosure relates to agricultural planting and related devices, systems, and methods.

### BACKGROUND

In various agricultural applications, moist soil is ideal for planting. Planting seeds at proper planting depth and in moist soil may provide for improved emergence and/or germination thereby improving overall yield. An important agronomic principle is that soil moisture increases the further below the soil surface a seed is planted.

Various prior art systems are configured to increase planting depth if seeds are being placed into inadequate moisture. Some of these prior known systems perform this adjustment in planting depth automatically and independently across all planter rows. However, deeper planting depths caused by these known systems may result in uneven planting depths among adjacent or nearby rows. Some agronomic schools of thought teach deeper planted seeds take longer to emerge than shallow. This may cause uneven emergence between nearby rows, which may decrease yields.

There is a need in the art for devices, systems, and methods for planting seed in ideal environments. What is needed is a planting technology that plants seeds in adequate moisture while keeping the planting depth uniform for all planter rows.

### BRIEF SUMMARY

Discussed herein are various devices, systems and methods relating to an on-the-go row cleaner depth adjustment system. The various systems are directed to an automated method of planting seeds into adequate soil moisture. In various implementations, dry soil is cleared from the top of the furrow rather than increasing planting depth, as such emergence time is not negatively impacted. In certain implementations, the dry soil is moved by adjusting the working depth of the row cleaner such as via increasing downforce on the row cleaner.

Further implementations relate to automatically adjusting row unit downforce settings, as has been previously described. In these implementations, increasing the downforce to the row cleaner will require more downforce on the entire row unit.

In various Examples, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In Example 1, a planting system comprising: a row unit, a row cleaner disposed on the row unit, a depth adjustment system operatively engaged with the row cleaner, a controller in operative communication with the depth adjustment system, and a soil moisture sensor in communication with the controller, wherein the controller is constructed and arranged to adjust row cleaner depth via the depth adjustment system in response to signals from the soil moisture sensor.

In Example 2, the system of Example 1, wherein the depth adjustment system comprises an actuator.

In Example 3, the system of Example 2, wherein the actuator controls supplemental downforce applied to the row cleaner.

In Example 4, the system of Example 1, wherein the row cleaner depth is adjusted in real-time or near real-time.

In Example 5, the system of Example 1, wherein the row cleaner depth is increased when the soil moisture sensor senses inadequate soil moisture.

In Example 6, the system of Example 5, wherein the row cleaner depth is decreased when the soil moisture sensor senses excessive soil moisture.

In Example 7, a row cleaner depth adjustment system for use with a moisture sensor, wherein the depth adjustment system is constructed and arranged to adjust the depth of the row cleaner in response to sensed moisture in order to plant seed in optimal moisture.

In Example 8, the system of Example 7, wherein the depth adjustment system increases the depth of the row cleaner when the moisture sensor detects inadequate moisture.

In Example 9, the system of Example 8, wherein the depth adjustment system is configured to command the row cleaner to remove a portion of dry top soil.

In Example 10, the system of Example 9, wherein depth adjustment system is configured to command the row cleaner to remove a portion of dry top soil to create a furrow top below a soil surface.

In Example 11, the system of Example 10, wherein a bottom of the furrow is maintained at a set depth relative to the top of the furrow.

In Example 12, the system of Example 11, wherein the bottom of the furrow is lowered relative to the soil surface height when the row cleaner depth is increased.

In Example 13, the system of Example 7, wherein the depth adjustment system adjusts supplemental downforce applied to the row cleaner.

In Example 14, a row unit comprising an adjustable row cleaner comprising an actuator, a moisture sensor, and a controller in communication with moisture sensor and the actuator, wherein the moisture sensor is constructed and arranged to send a signal to the controller regarding soil moisture level, and wherein the controller sends an output signal to the adjustable row cleaner corresponding to the soil moisture level.

In Example 15, the row unit of Example 14, wherein output signal increases adjustable row cleaner depth when the soil moisture level is less than optimal.

In Example 16, the row unit of Example 15, wherein output signal decreases the depth of the adjustable row cleaner when the soil moisture level is more than optimal.

In Example 17, the row unit of Example 16, further comprising a supplemental downforce system wherein the supplemental downforce system adjusts downforce of the row unit.

In Example 18, the row unit of Example 17, wherein the downforce of the row unit is adjusted corresponding to adjustments in row cleaner depth.

In Example 19, the row unit of Example 18, wherein the downforce of the row unit is increased when the depth of the adjustable row cleaner is increased.

In Example 20, the row unit of Example 19, wherein the downforce of the row unit is decreased when the depth of the adjustable row cleaner is decreased.

Other embodiments of this aspect include corresponding computer systems, apparatus, and computer programs recorded on one or more computer storage devices, each configured to perform the actions of the methods.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a planter, according to one implementation.

FIG. 2 is a side view of tractor and planter, according to one implementation.

FIG. 3A is a side view of a row unit, according to one implementation.

FIG. 3B is a side view of a firmer with moisture sensor, according to one implementation.

FIG. 3C is a side view of a row unit, according to one implementation.

FIG. 3D is a perspective view of a row cleaner, according to one implementation.

FIG. 4A is a side view of a row unit, according to one implementation.

FIB. 4B is a schematic view of a row unit, according to one implementation.

FIG. 5A is a flow diagram for a row cleaner depth adjustment system, according to one implementation.

FIG. 5B is a process diagram of the row cleaner system, according to one implementation.

FIG. 5C is a process diagram of the row cleaner system, according to one implementation.

### DETAILED DESCRIPTION

The various embodiments disclosed or contemplated herein relate to the use of a soil moisture sensor in a seed trench as an input to a control method for automating row cleaner depth control. Planting seeds in moist soil can improve seed germination and plant emergence and thereby increase overall yield.

As opposed to prior art approaches that seek to plant seeds at increasing depths to achieve sufficient moisture, the disclosed row by row on-the-go row cleaner system 10 adjusts row cleaner working depth. That is, in these implementations, the system clears unwanted, dry topsoil ahead of the gauge wheels and opening discs, thereby allowing the seeds to be planted in moist soil without increasing planting depth.

It is understood that the various implementations of the on-the-go row cleaner systems 10 disclosed herein can be incorporated into or used with any other known agricultural planting systems, device, and methods.

For example, the various implementations disclosed herein may be incorporated into or used with any of the agricultural device, systems, and methods disclosed in co-pending U.S. applications Ser. No. 16/684,877 (filed Nov. 15, 2019 and entitled “On the go organic matter sensor and associated systems and methods”), Ser. No. 16/670,692 (filed Oct. 31, 2019 and entitled “Soil sensing control devices, systems, and associated methods”), Ser. No. 16/523,343 (filed Jul. 26, 2019 and entitled “Closing Wheel Downforce Adjustment Devices, Systems, And Methods”), Ser. No. 16/371,815 (filed Apr. 1, 2019 and entitled “Devices, Systems, and Methods for Seed Trench Protection”), Ser. No. 16/121,065 (filed September 4, 2018 and entitled “Planter Down Pressure And Uplift Devices, Systems and Associated Methods”), and Ser. No. 62/940,718 (filed Nov. 26, 2019 and entitled “Devices, Systems and Methods for Seed Trench Monitoring and Closing”), all of which are hereby incorporated herein by reference in their entireties.

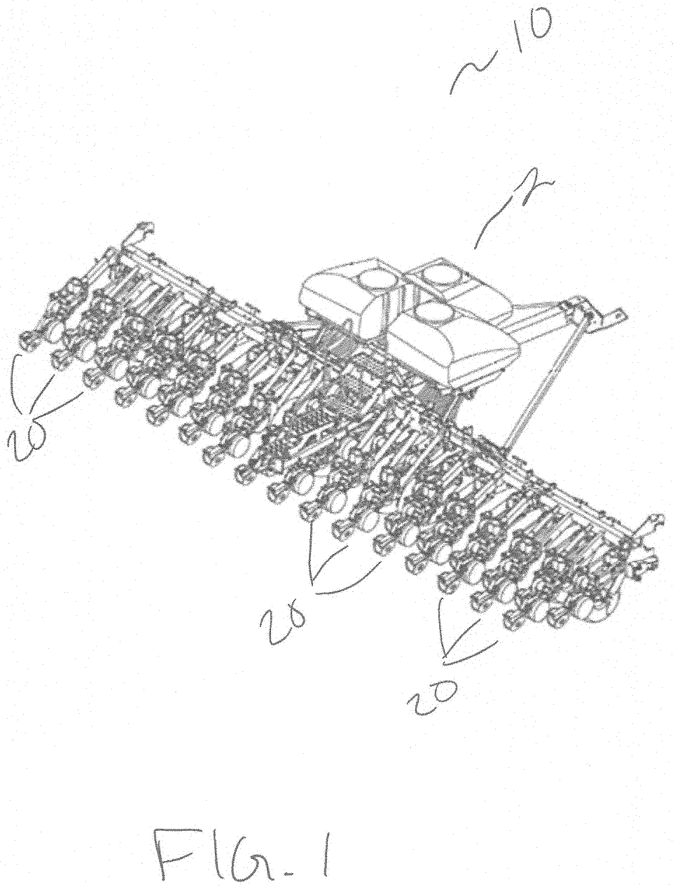

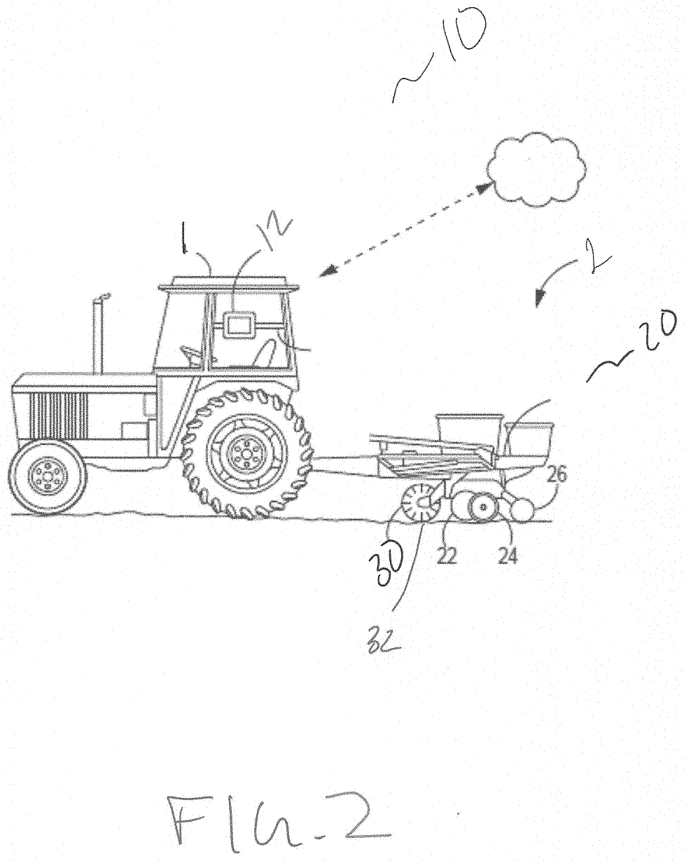

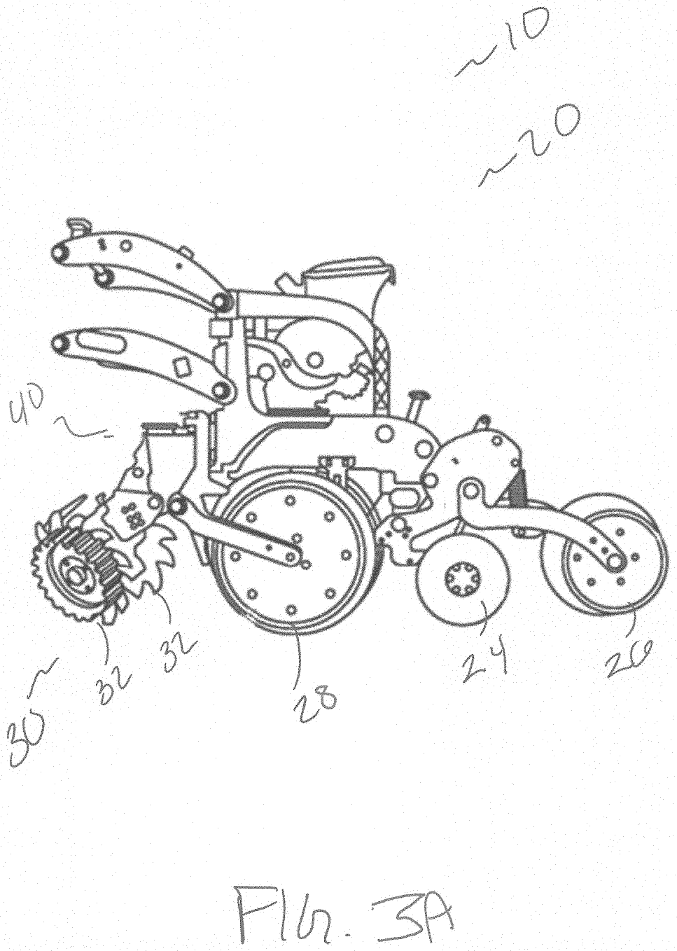

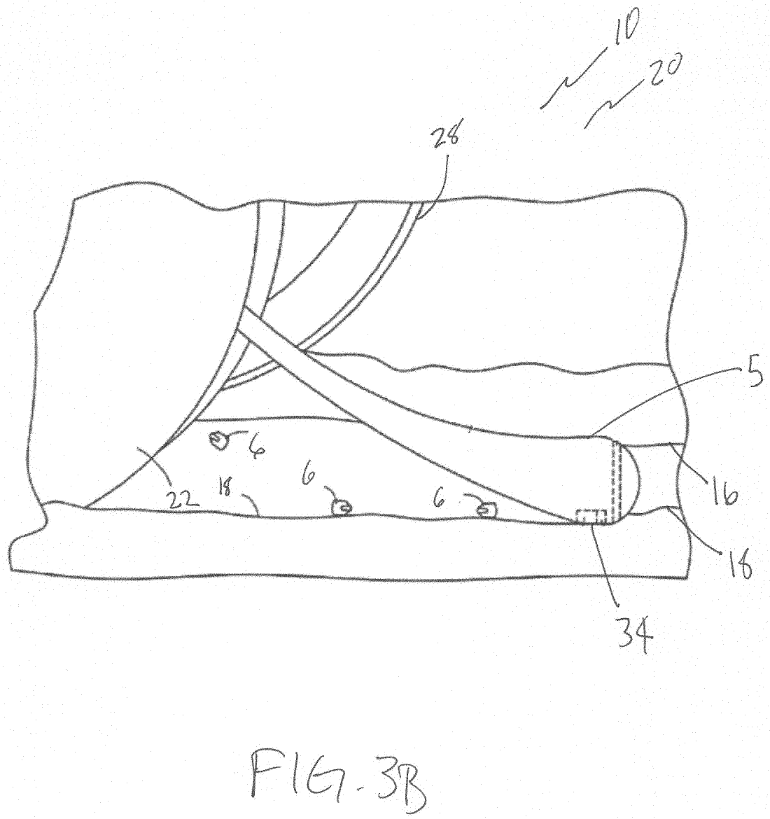

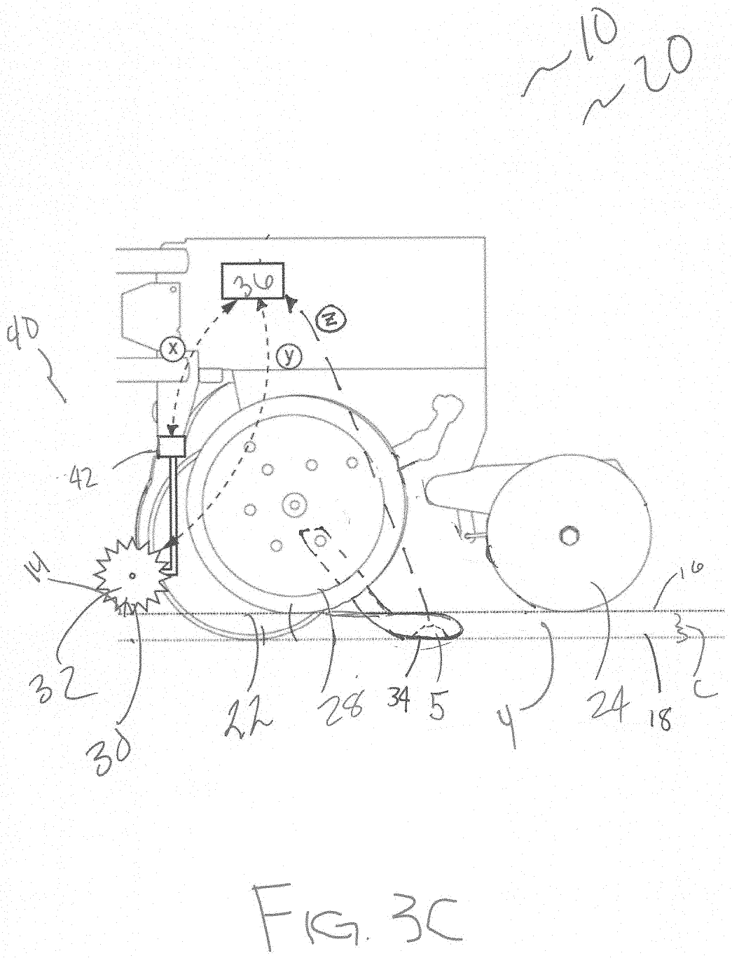

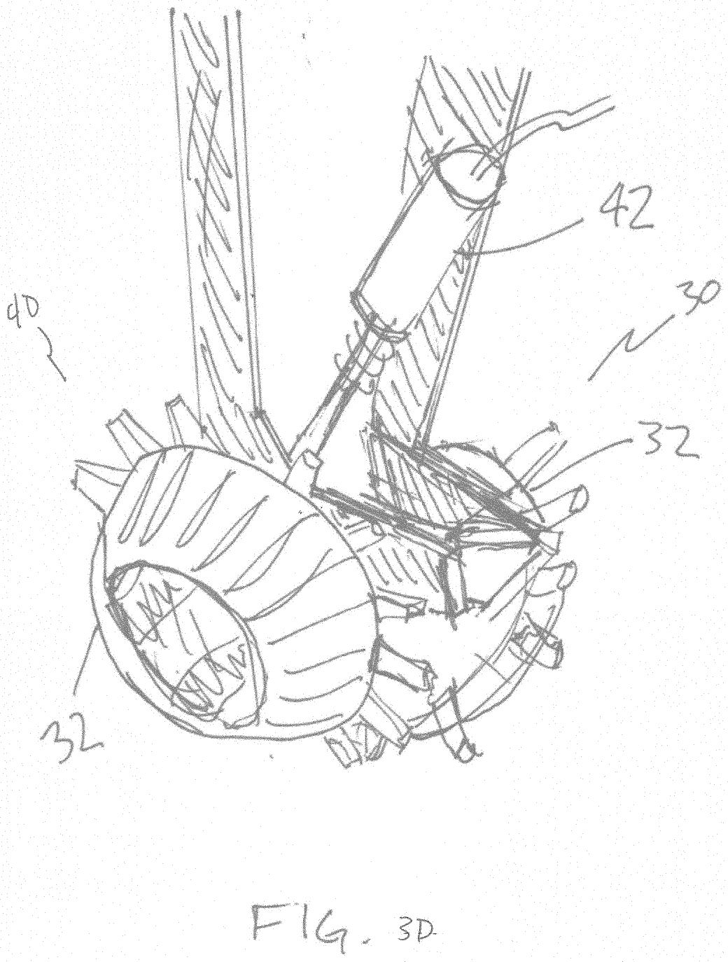

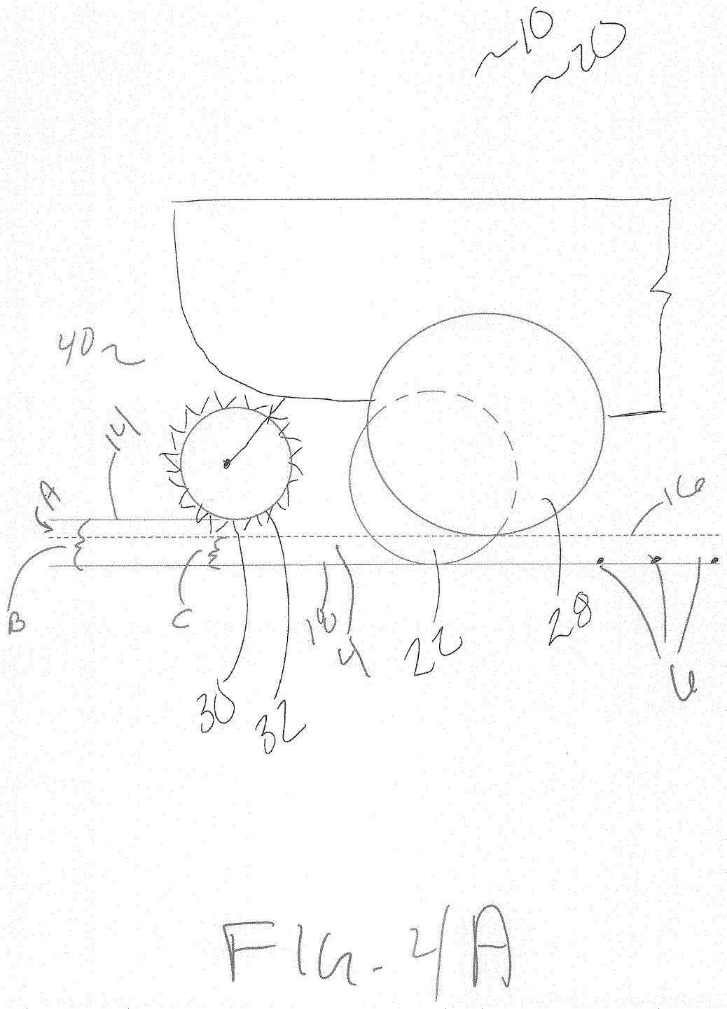

Turning to the figures in greater detail, various implementations of the disclosed closing system 10 are adapted to operate with a planter 2—shown for example in FIGS. 1 and 2—that includes a plurality of row units 20 constructed and arranged for planting crops such as corn, optionally at high speed. Various row unit 20 configurations are known in the art and certain exemplary row units 20 are shown in FIGS. 3A-5B. It would be appreciated by those of the skill in the art that the various devices, systems, and methods disclosed and contemplated herein may be used in connection with any row unit 20.

Briefly as is shown in FIG. 2, the row unit 20 is disposed on a planter 2, such as behind a tractor 1 having a control unit and monitor 12, has been previously described in the incorporated references. In these implementations, and as shown in FIGS. 2-5B the row unit 20 optionally has one or more of opening discs 22, closing wheels 24, a press wheel 26, a gauge wheel(s) 28, and a row cleaner 30.

As shown in FIGS. 3A-3C, in further implementations, the row unit 20 may also include various sensor(s) 34 in operational communication with one or more controller(s) 36. These row units 20 typically also have one or more downforce systems for the application of supplemental downforce to the row unit 20 and/or other components, including a supplemental row cleaner downforce system 40 that is in communication with the row cleaner 30. Certain row units 20 may include all or some of these components, as is well understood in the art, and the specific configurations can change depending on use.

In certain implementations of the system 10, each row unit 20 has a row cleaner 30 with row cleaning discs 32. It is appreciated that a row cleaner 30 typically operates to clear crop residue, clods, debris, and other foreign material in front of the opening discs 22 prior to the row unit 20 opening the seed trench and depositing a seed.

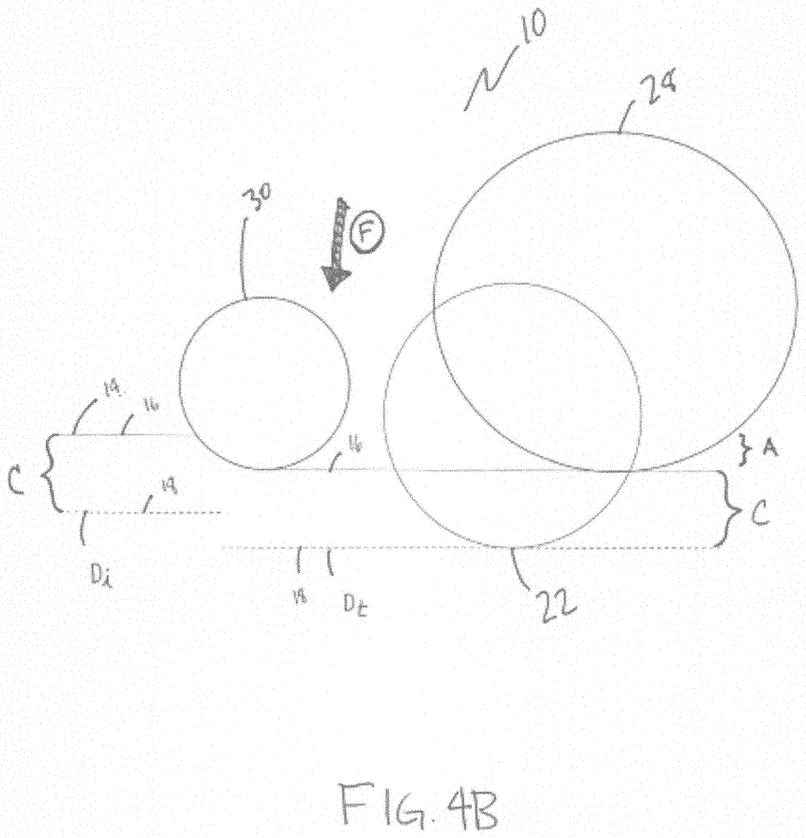

It is appreciated that seed trenches are typically formed in soil by such row units 20 during planting operations. In various implementations, the seed trench or furrow (shown for example at 4 in FIGS. 4A-4B) is formed by the opening discs 22 disposed on the row unit 20. The seed trench is created such that seeds are planted at an optimal planting depth, where the planting depth is considered to be the amount of soil between the soil surface at the top of the furrow, and the bottom of the furrow where the seed is deposited. In further implementations, after planting, the seed trench 4 is closed via a closing wheel 24 or pair of closing wheels 24. In still further implementations, the closed trench may be further closed/firmed/pressed via the press wheel 26.

As best shown in FIG. 3B, various implementations of the on-the-go row cleaner system 10 have a moisture sensor 34 constructed and arranged to sense the amount of moisture in the soil. In use, when the moisture sensor 34 indicates that the seed trench has inadequate moisture, such that the system 10 is able to automatically increase the depth of the row cleaner 30, such as by increasing the amount of downforce applied to the row cleaner 30. It will be appreciated that this increase in row cleaner depth will in turn cause the row cleaner 30 to remove more dry soil from the top of the seed trench 4 and clear the ground such that seed is planted in moister soil and at sufficient depth to prevent late emergence.

Turning to the implementations of the system 10 shown in FIGS. 3C-3D, the sensors 34 and actuator 42 are in communication with one or more controllers 36, that are in turn in communication with the row cleaner 30 and adjustment system 40 and configured to execute the various process steps described herein. That is, the one or more sensors 34 of an individual row unit are in electronic or data communication Here, the connections (shown for example at x, y and z) between these components are electrical and/or wired or wireless, as would be appreciated.

In various implementations, the sensors 34 are soil moisture sensors 34, such as those described in U.S. Pat. 9,629,304 and U.S. patent application Ser. No. 16/142,522, both of which are incorporated by reference in their entirety.

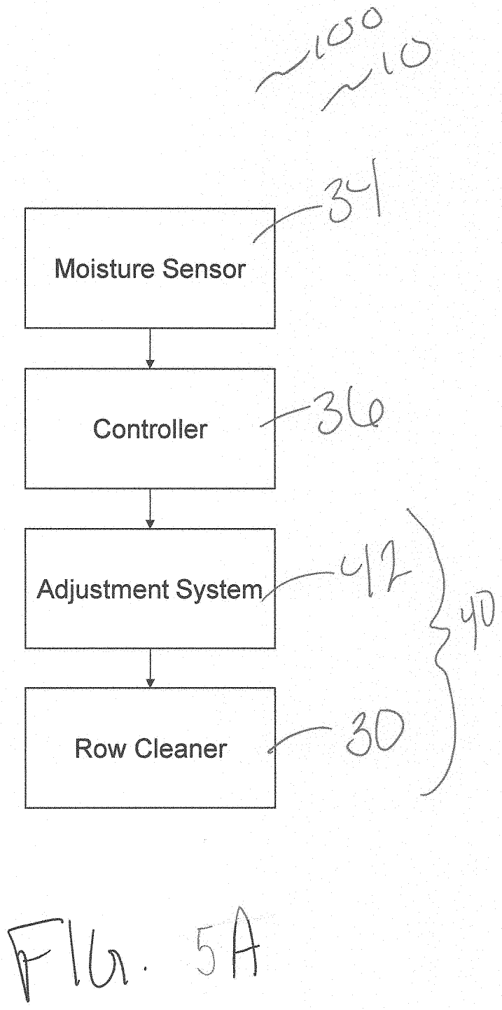

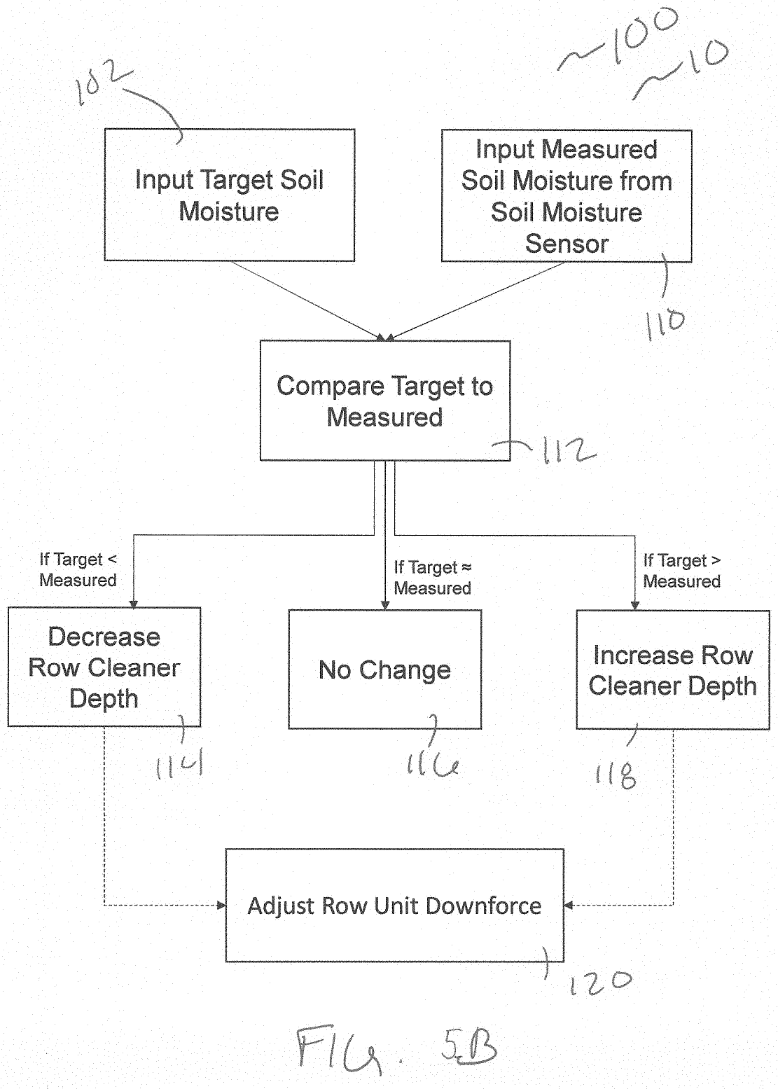

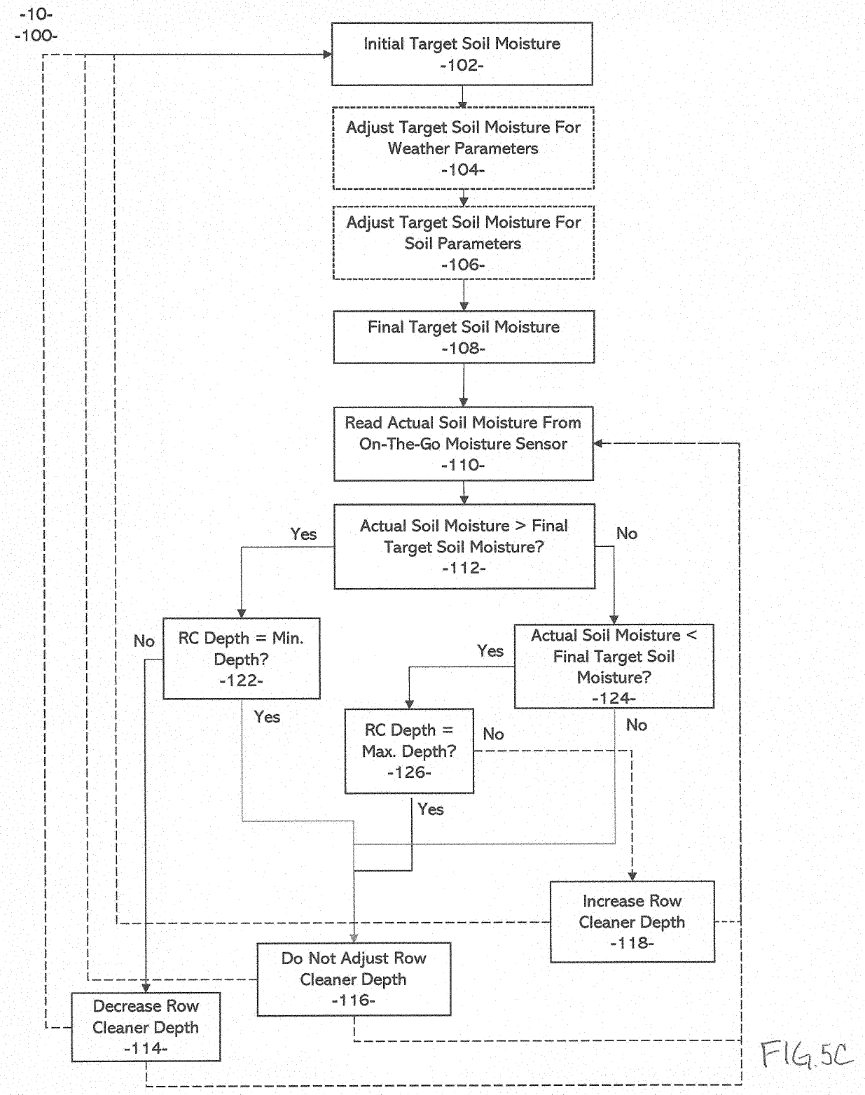

Briefly, in various implementations, the moisture sensor 34 senses the amount a moisture in the soil. The moisture sensor 34 sends a corresponding signal to the controller 36. The controller 36 is constructed and arranged to interpret the input signal from the moisture sensor 34 and send an output signal to the adjustment system 40 and/or actuator 42 for depth adjustment of the row cleaner 30. As needed, or as required, the adjustment system 40 operates to adjust the depth of the row cleaner 30 to account for the target depth Dₜ, as described below in relation to FIG. 4B and diagrammed for example in FIG. 5A.

FIGS. 4A-4B illustrate exemplary implementations of the row cleaner system 10 in use. The system 10 may be used for adjusting row cleaner depth on-the-go based on feedback from an on-the-go soil moisture sensor 34 of FIG. 3B and may be implemented as a control algorithm using an intelligent control. The soil moisture sensor 34 measures moisture at the planting depth, as seeds 6 are planted and this information is used to control planting and row cleaner 30 depth.

As shown in FIG. 4A, the system 10 according to certain implementations can vary the relative depths of the row cleaner 30 and opening discs 22 in relation to one another to alter the relative distances between the soil surface height 14, the top of the furrow 16 and the bottom of the furrow 18, respectively. In one such implementation, and as shown in FIG. 4A, the system 10 has a row cleaner 30 traversing the soil ahead of the gauge wheel 28 and opening discs 22. In this implementation, the row cleaner 30 will remove a portion of soil between the soil surface height 14 and the top of the furrow 16 (shown at A) ahead of the gauge wheels 28 and opening discs 22, thereby causing the initial point of contact for the gauge wheels 28 and opening discs 22 to occur at the top of furrow 16 surface, as defined by the system 10.

It is appreciated that in such implementations, the seed 6 will still be planted at the bottom of the furrow 18, but will be at an increased depth relative to the soil surface height 14 (shown at B) ahead of the row cleaner 30. That is, in such implementations, the increased downforce applied to the row cleaner 30, or other row cleaner 30 depth adjustment, results in the row cleaner 30 removing soil ahead of the row unit 20 and opening processes such that the seed 6 is deposited at increased depth relative to the soil surface height 14 (shown at B), but at a specified or normal depth between the top of the furrow 16 and bottom of the furrow 18 (shown at C) that will not hinder plant emergence, as would be readily understood.

In an exemplary embodiment shown in FIG. 4B, the system 10 is set to a furrow depth C of 2 inches, although other planting depths C are possible as would be recognized by those of skill in the art. It is therefore appreciated that without an adjustment to the row cleaner 30 depth, the seed would be planted at the initial planting depth Dᵢ—about 2 inches below the soil surface height 14.

However, according to these implementations of the system 10, upon sensing via moisture sensor 34 that the soil contains insufficient moisture at the initial planting depth Dᵢ, the controller 36 issues a signal for increasing the depth (shown by reference arrow F) of the row cleaner 30, for example by increasing the downforce applied to the row cleaner 30, thereby clearing top soil and bringing the opening discs 22 and gauge wheel 28 lower to achieve target planting depth Dₜ.

In one specific implementation about one inch of dry soil is removed between the soil surface height 14 and top of the furrow 16, though one of skill in the art will appreciate that any distance between a small fraction of an inch and several inches is possible with inches to be consistent with other parts.

In the implementation of FIG. 4B, the target planting depth Dₜ is therefore about three inches deep relative to the undisturbed soil surface height 14, but after the row cleaner has removed the 1″ of dry top soil, the bottom of the furrow is 2″ below the new soil surface at the top of the furrow 16, thereby the effective planting depth is 2″ and the seed is deposited into adequate soil moisture without excessive planting depth, therefore preventing late emergence.

In another example the soil moisture may be adequate at about 3″ below the soil surface height 14, but the target planting depth Dₜ is about 1.5″. In this example, the system 10 will adjust the depth of the row cleaner 30 to automatically remove about 1.5″ of soil from between the soil surface height 14 and the top of the furrow 16. In this example, the row unit 20 may then deposit the seed at the target planting depth Dₜ about 1.5″ deep, but into the soil having adequate moisture that is about 3″ deep relative to the soil surface height 14.

Various implementations of the system 10 allow the planter 2 to use its normal planting depth range of approximately about 0.5″ to about 4″, but shift the planting depth C about 0.1″ to about 2″ deeper in order to deposit seeds into adequate moisture without increasing planting depth C. Further desirable ranges would be readily appreciated by those of skill in the field.

It is understood that in certain implementations, the row cleaner 30 depth and planting depth can be adjusted together or in opposite directions on-the-go, such that the row cleaner 30 may be initially set to remove a portion of soil from the soil surface height 14, such as about 1″ from the soil surface height 14, and the target planting depth Dₜ can be initially set to any appropriate depth as would be recognized, such as about two inches.

In use under various conditions, the system 10 row cleaner 30 depth and/or planting depth may be adjusted on-the-go in a relative manner. That is, the planting depth and row cleaner depth can be increased or decreased in conjunction with one another or, alternatively, be increased and decreased in opposite directions to accommodate for specific crops and planting conditions. For example, the row cleaner 30 depth may be set to clear about one inch, about one and a half inches, about a half inch or any of the other depths that would be understood by the skilled artisan, while the planting depth can be independently adjusted to be about two inches, more than two inches or less than two inches as desired or otherwise prescribed by the system 10, such as via the on-the-go algorithm detailed in U.S. Pat. No. 9,629,304, which was incorporated by reference.

To perform on-the-go adjustments according to certain implementations, the system 10 executes an on-the-go row by row depth cleaner algorithm 100. It is understood that a wide variety of such algorithms are possible, and that the implementations detailed in FIGS. 5A-C are exemplary algorithms 100 depicting a series of optional steps, while alternate implementations are of course possible. It is further understood that the algorithm 100 is executed independently for each row unit 20 such that the individual row units are making individual row cleaner adjustments.

The algorithm 100 may comprise one or more steps that can be performed in any order or not at all, and various implementations omit certain steps or add additional steps, as would be readily appreciated.

As shown in FIG. 5A, the system 10 operates via communication between one or more components as described above. In various implementations, the moisture sensor 34 senses the amount a moisture in the soil. The moisture sensor 34 sends a corresponding signal to the controller 36. The controller 36 is constructed and arranged to interpret the input signal from the moisture sensor 34 and send an output signal to the adjustment system 40 and/or actuator 42 for depth adjustment of the row cleaner 30. As needed, or as required, the adjustment system 40 operates to adjust the depth of the row cleaner 30 to account for the target depth Dₜ, as described above in relation to FIG. 4B.

Turning now to the implementation of the algorithm in FIG. 5B, the system 10 and controller 36 are configured to perform one of more steps. In FIG. 5B, a target soil moisture is inputted (box 102) into the system 10. As described above, the controller 36 may also receive an input from the soil moisture sensor 34 corresponding to the measured soil moisture (box 110). In a further step, the system 10 compares the target soil moisture to the measured soil moisture (box 112). In alternate implementations, further data may be inputted into the system via sensor(s), some non-limiting examples including soil temperature, crop residue sensor data and soil type. Further data inputs, such as those in the incorporated references, are of course possible.

In various implementations, if the measured soil moisture is greater than target soil moisture, the controller 36 may send a signal to the adjustment system 40 to decrease row cleaner depth (box 114). If the target soil moisture is equal to, or about equal to, the measured soil moisture, the controller 36 will not send an output to the adjustment system 40 and the row cleaner 30 will maintain its depth (box 116). In certain implementations, where the measured soil moisture is less than the target soil moisture, the controller 36 sends an output signal to the adjustment system 40 to increase row cleaner depth (box 118).

As shown in the exemplary embodiment of FIG. 5C, in one optional step a user may identify and optionally input the target soil moisture (box 102). This target soil moisture may be the amount of moisture required in a field for optimum seed emergence. In another optional step, the initial target soil moisture may be adjusted for weather parameters such as future precipitation forecasts (box 104). In a further optional step, the initial target soil moisture may also be adjusted for soil profiles and field topography (box 106).

A final target soil moisture may then be determined (box 108). The desired final target soil moisture may be determined (box 108), such as by using the parameters from boxes 102, 104, and/or 106. In an alternative step the final target soil moisture may also be inputted by the user into a monitor 12 (shown in FIG. 3).

In a further optional step moisture is measured at the planting depth as seeds are planted on-the-go by the soil moisture sensors 34 (box 110). In another optional step, a determination is made as to whether the actual soil moisture is greater than the final target soil moisture (box 112). If it is, then in a further optional step a determination is made as to whether the row cleaner 30 depth is equal to the minimum row cleaner depth (box 122). If the row cleaner 30 depth is equal to the minimum depth, then a determination is made to not adjust the row cleaner 30 depth (box 116). If the row cleaner 30 depth is not equal to the minimum row cleaner 30 depth, the row cleaner 30 depth is decreased (box 114).

In a further optional step, if the actual soil moisture is not greater than the final target soil moisture then a determination is made as to whether the actual soil moisture is less than the final target soil moisture (box 124). If it is then a determination is made as to whether the row cleaner 30 depth is equal to the maximum row cleaner 30 depth (box 126). If it is then in a further optional step the row cleaner 30 depth is not adjusted (box 116). If it is not, then optionally the row cleaner 30 depth is increased (box 118).

In a further optional step, if the actual soil moisture is not greater than the final target soil moisture then the row cleaner depth is not adjusted (box 116).

In a still further optional step, after adjusting the row cleaner 30 depth, whether it be decreasing row cleaner depth (box 114) or increasing row cleaner depth (box 118), the system 10 may perform the optional step of relieving the row unit 20 down pressure while the actuator 42 is adjusting row cleaner 30 depth (box 120). Regardless of whether or not the optional step is performed, the system 10 may then execute the sensing and adjustment steps iteratively throughout the planting process.

In various implementations, adjustment of the row cleaner 30 depth is automatic, such as via an algorithm 100. In alternative implementations, the system 10 may be constructed and arranged to alert a user when soil moisture is insufficient, such that the user may manually adjust row cleaner 30 depth. In further implementations, as discussed above, the row unit 20 downforce may be adjusted in a corresponding fashion, either manually or automatically.

In some implementations, adjustments to the row cleaner 30 depth are made in real-time or near real-time during planting.

Although the disclosure has been described with references to various embodiments, persons skilled in the art will recognized that changes may be made in form and detail without departing from the spirit and scope of this disclosure.

What is claimed is:

1. A planting system comprising:
(a) a row unit;
(b) a row cleaner disposed on the row unit;
(c) a depth adjustment system operatively engaged with the row cleaner;
(d) a controller in operative communication with the depth adjustment system; and
(e) a soil moisture sensor in communication with the controller,
wherein the controller is constructed and arranged to adjust row cleaner depth via the depth adjustment system in response to signals from the soil moisture sensor.

2. The system of claim 1, wherein the depth adjustment system comprises an actuator.

3. The system of claim 2, wherein the actuator controls supplemental downforce applied to the row cleaner.

4. The system of claim 1, wherein the row cleaner depth is adjusted in real-time or near real-time.

5. The system of claim 1, wherein the row cleaner depth is increased when the soil moisture sensor senses inadequate soil moisture.

6. The system of claim 5, wherein the row cleaner depth is decreased when the soil moisture sensor senses excessive soil moisture.

7. A row cleaner depth adjustment system for use with a moisture sensor, wherein the depth adjustment system is constructed and arranged to adjust the depth of the row cleaner in response to sensed moisture in order to plant seed in optimal moisture.

8. The system of claim 7, wherein the depth adjustment system increases the depth of the row cleaner when the moisture sensor detects inadequate moisture.

9. The system of claim 8, wherein the depth adjustment system is configured to command the row cleaner to remove a portion of dry top soil.

10. The system of claim 9, wherein depth adjustment system is configured to command the row cleaner to remove a portion of dry top soil to create a furrow top below a soil surface.

11. The system of claim 10, wherein a bottom of the furrow is maintained at a set depth relative to the top of the furrow.

12. The system of claim 11, wherein the bottom of the furrow is lowered relative to the soil surface height when the row cleaner depth is increased.

13. The system of claim 7, wherein the depth adjustment system adjusts supplemental downforce applied to the row cleaner.

14. A row unit comprising:
(a) an adjustable row cleaner comprising an actuator;
(b) a moisture sensor; and
(c) a controller in communication with moisture sensor and the actuator,
wherein the moisture sensor is constructed and arranged to send a signal to the controller regarding soil moisture level, and wherein the controller sends an output signal to the adjustable row cleaner corresponding to the soil moisture level.

15. The row unit of claim 14, wherein output signal increases adjustable row cleaner depth when the soil moisture level is less than optimal.

16. The row unit of claim 15, wherein output signal decreases the depth of the adjustable row cleaner when the soil moisture level is more than optimal.

17. The row unit of claim 16, further comprising a supplemental downforce system wherein the supplemental downforce system adjusts downforce of the row unit.

18. The row unit of claim 17, wherein the downforce of the row unit is adjusted corresponding to adjustments in row cleaner depth.

19. The row unit of claim 18, wherein the downforce of the row unit is increased when the depth of the adjustable row cleaner is increased.

20. The row unit of claim 19, wherein the downforce of the row unit is decreased when the depth of the adjustable row cleaner is decreased.
